(19) United States
(12) Patent Application Publication
(10) Pub. No.: US 2010/0020667 A1
(43) Pub. Date: Jan. 28, 2010

(54) INFORMATION PROCESSING APPARATUS, INFORMATION PROCESSING METHOD, AND PROGRAM

(75) Inventor: Kouichi IDENO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/489,595

(22) Filed: Jun. 23, 2009

(30) Foreign Application Priority Data
Jul. 23, 2008 (JP) 2008-189392

(51) Int. Cl. G11B 3/64

(52) U.S. Cl. 369/84; G9B/3.097

(57) ABSTRACT

An information processing apparatus includes: recording means for recoding contents; and transfer means for determining recording media at transfer destinations of respective contents recorded in the recording means among recoding media in recording devices linked via a network by comparing information about contents to be transferred with information about contents recorded in the recording media in the respective recording devices and transferring the contents.

### BACKGROUND OF THE INVENTION

1. Field of the Invention

The present invention relates to an information processing apparatus, an information processing method, and a program. More particularly, the present invention relates to an information processing apparatus, an information processing method, and a program configured to make it possible to transfer contents of interest easily to a transfer destination suitable to the contents.

2. Background Art

Recording devices capable of recording HD (High Definition) contents, such as a Blu-ray (registered trademark) recorder, are now becoming popular.

Also, owing to developments of the network technology, such as the DLNA (Digital Living Network Alliance), it is now possible to transfer contents recorded in a recording device to another recording device via a network for the user to view the contents using the recording device at the transfer destination.

JP-A-2007-156804 discloses a technique of transferring contents to a memory medium specified by the user as the transfer destination.

### SUMMARY OF THE INVENTION

An increase in data volume of contents associated with enhancement of the image quality and developments of the automatic recording capability that enables automatic recording without any operation by the user accelerate a rate at which an available capacity of the recording medium incorporated in the recording device is reducing.

When an available capacity of the recording medium in a recording device becomes small, the contents may be transferred from this recording device to another recording device having a relatively sufficient available capacity via the network. This transfer processing in the related art, however, involves tedious operations. For example, the user has to specify periodically by hand as to which contents are to be transferred to which device.

In a case where recording devices are used for intended purposes, for instance, one recording device is used for movie viewing and another recording device is used for normal programs, or in a case where main users of respective recording devices are different, it is necessary to specify a transfer destination to best suit the purpose, the main user, and the user's taste. It is anticipated that a time will soon come when a family owns more than one recording device, which raises a need to take the purpose and the user's taste into consideration.

It is therefore desirable to make it possible to transfer contents of interest easily to a transfer destination that suits the contents.

According to an embodiment of the present invention, there is provided an information processing apparatus including recording means for recording contents, and transfer means for determining recording media at transfer destinations of respective contents recorded in the recording means among recoding media in recording devices linked via a network by comparing information about contents to be transferred with information about contents recorded in the recording media in the respective recording devices and transferring the contents.

The transfer means may determine a recording medium in any of the recording devices that has recorded contents under a same title as a title of the contents to be transferred as a recording medium at a transfer destination.

In a case where more than one of the recording media in the recording devices has recorded the contents under the same title as the title of the contents to be transferred, the transfer means may determine a recording medium having a largest number of the contents under the same title as the recording medium at the transfer destination.

In a case where none of the recording media in the recording devices has recorded the contents under the same title as the title of the contents to be transferred, the transfer means may determine a recording medium that has recorded contents in a same genre as a genre of the contents to be transferred as the recording medium at the transfer destination.

In a case where more than one of the recording media in the recording devices has recorded the contents in the same genre as the genre of the contents to be transferred, the transfer means may determine a recording media having a highest ratio of the number of contents in the same genre as the recording medium at the transfer destination.

According to another embodiment of the present invention, there is provided an information processing method or a program including the steps of determining recording media at transfer destinations of respective contents recorded in recording means for recording contents among recoding media in recording devices linked via a network by comparing information about contents to be transferred with information about contents recorded in the recording media in the respective recording devices and transferring the contents.

According to still another embodiment of the present invention, recording media at transfer destinations of respective contents recorded in recording means for recording contents are determined among recoding media in recording devices linked via a network by comparing information about contents to be transferred with information about contents recorded in the recording media in the respective recording devices and the contents are transferred.

According to the embodiments of the present invention, it is possible to transfer contents of interest easily to a transfer destination that suits the contents.

### BRIEF DESCRIPTION OF THE DRAWINGS

FIG. 1 is a view showing an example of the configuration of a contents transfer system according to an embodiment of the present invention;

FIG. 2 is a view showing an example of a manner in which a transfer destination is determined;

FIG. 3 is a block diagram showing an example of the hardware configuration of a parent recorder;

FIG. 4 is a block diagram showing an example of the functional configuration of the parent recorder;

FIG. 5 is a flowchart depicting transfer processing by the parent recorder; and

FIG. 6 is a flowchart depicting best suited transfer destination determination processing performed in Step S4 of FIG. 5.

### DESCRIPTION OF THE PREFERRED EMBODIMENT

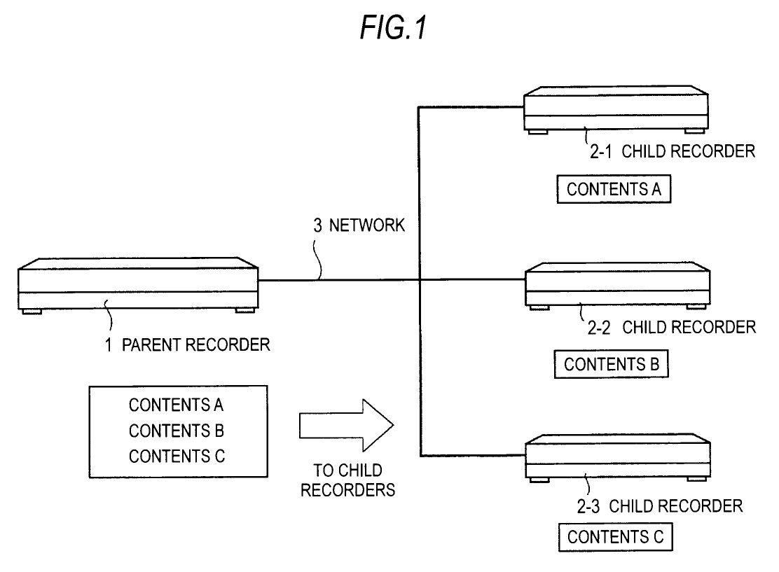

FIG. 1 is a view showing an example of the configuration of a contents transfer system according to an embodiment of the invention.

As is shown in FIG. 1, the contents transfer system includes a parent recorder 1 that is connected to child recorders 2-1 through 2-3 via a network 3. The number of the child recorders is arbitrary. For example, the parent recorder 1 and the child recorders 2-1 through 2-3 are installed in different rooms in a house and display devices, such as TV sets, are connected at least to the child recorders 2-1 through 2-3.

The parent recorder 1 serving as an information processing apparatus has a recording capability and makes an internal recording medium, such as an HDD (Hard Disk Drive), record therein contents provided via broadcast waves or via the Internet. An antenna that receives broadcast waves and communication device, such as a router, to establish a link to the Internet are connected to the parent recorder 1 either wirelessly or by cable.

Each of the child recorders 2-1 through 2-3 serving as a recording device incorporates a drive capable of writing data into a recording medium, such as an HDD, and a removable medium, such as a Blu-ray disc. The child recorders 2-1 through 2-3 themselves may have the recording capability.

In the contents transfer system having the devices as above, recorded contents are transferred to the child recorders 2-1 through 2-3 from the parent recorder 1 every time contents are recorded or at predetermined timing, such as once in every day or every week.

The term, “transfer”, referred to herein means to record data into a recording medium at the transfer destination alone without leaving any data in a recording medium at the transfer source. As has been described, the drive is provided to each child recorder in addition to the internal HDD. In a case where a Blu-ray disc is loaded into the drive, not only the HDD but also the Blu-ray disc is selected as the recording medium at the transfer destination where appropriate.

In the example of FIG. 1, of the contents A, B, and C recorded in the parent recorder 1, the contents A are transferred to the child recorder 2-1, the contents B to the child recorder 2-2, and the contents C to the child recorder 2-3 as is indicated by a blank arrow.

By transferring the recorded contents, it becomes possible to secure an available capacity of the recording medium in the parent recorder 1, which enables the parent recorder 1 to record new contents. In addition, the users of the respective child recorders become able to view the contents transferred from the parent recorder 1 using their own child recorders.

When contents are transferred from the parent recorder 1 to the child recorders 2-1 through 2-3, a recording medium suitable as the transfer destination is determined for respective contents first and thence the contents are transferred.

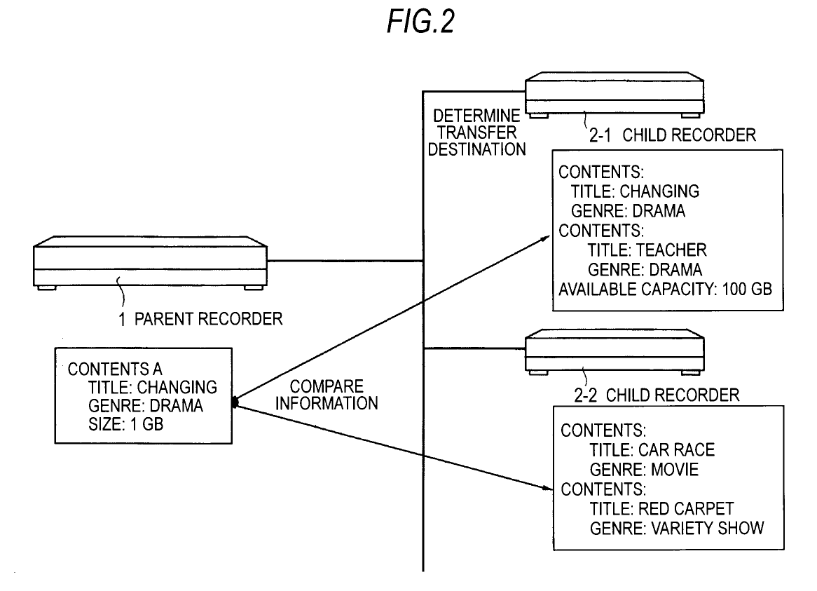

FIG. 2 is a view showing an example of a manner in which the transfer destination is determined.

As is shown on the left side of FIG. 2, in a case where the contents A are selected as the contents to be transferred, information about the contents A is compared with information about the contents already recorded in the recording media in the respective child recorders 2-1 through 2-3 to determine the transfer destination of the contents A. Information about the contents contained in EPG (Electronic Program Guide) data is appended to the contents recorded in the parent recorder 1 and the child recorders 2-1 through 2-3. Information about the contents includes the title and the genre of the contents.

In the example of FIG. 2, the title of the contents A is “CHANGING”, the genre is “drama”, and the size (data volume) is “1 GB”. Contents under the title of “CHANGING” and in the genre of “drama” and contents under the title of “TEACHER” in the genre of “drama” are recorded in the recording medium in the child recorder 2-1 having an available capacity of 100 GB. Contents under the title of “CAR RACE” in the genre of “movie” and contents under the title of “RED CARPET” in the genre of “variety show” are recorded in the recording medium in the child recorder 2-2.

For example, each of the parent recorder 1 and the child recorders 2-1 through 2-3 is furnished with a communication capability in conformity with the DLNA (Digital Living Network Alliance). According to communications in conformity with the DLNA, it is possible for the parent recorder 1, which is an outside device, to obtain information about contents recorded in the recording media in the respective child recorders.

In a case where the contents as above are recorded in the respective devices, the parent recorder 1 determines the child recorder 2-1 that has recorded the contents under the same title as the title of the contents A to be transferred as the transfer destination on the basis of the comparison result and performs the transfer processing.

For example, in a case where the contents under the title of “CHANGING” are a serial dram broadcasted every week at a predetermined time slot, the contents under the title of “CHANGING” recorded in the parent recorder 1 are transferred to the child recorder 2-1 each time. Once the user of the child recorder 2-1 operates the parent recorder 1 manually to transfer the contents under the title of “CHANGING” to the child recorder 2-1, he then becomes able to view the contents under the title of “CHANGING” that will be transferred automatically using the child recorder 2-1.

In a case where there is more than one recording medium that has recorded the contents under the same title as the title of the contents A to be transferred, it may be configured in such a manner that the recording medium having the largest number of contents under the same title is determined as the transfer destination.

In a case where there is no recording medium that has recorded the contents under the same title as the tile of the contents to be transferred, it may be configured in such a manner that a recording medium that has recorded contents in the same genre is determined as the transfer destination. Alternatively, a recording medium that has recorded contents in the same genre at the highest ratio may be determined as the transfer destination.

By determining the recording medium that has recorded the contents in the same genre as the genre of the contents to be transferred as the transfer destination, the user of the child recorder becomes able to view the contents of his taste transferred from the parent recorder 1 using the child recorder.

It should be noted that a recording medium having an insufficient capacity for a data volume of the contents to be transferred is removed from candidates of the transfer destination.

Operations of the parent recorder 1 to determine the transfer destination and to transfer the contents will be described below with reference to the flowchart.

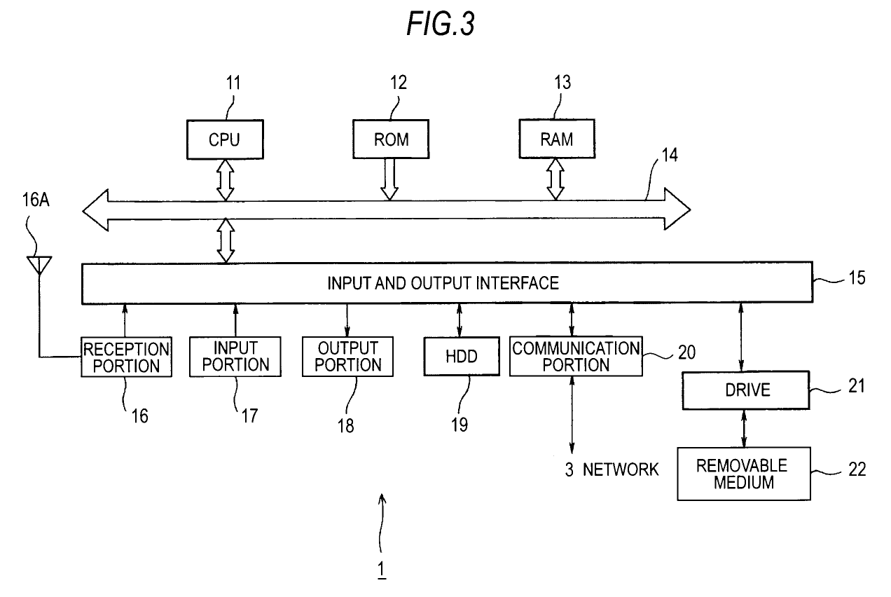

FIG. 3 is a block diagram showing an example of the hardware configuration of the parent recorder 1.

Various types of processing are executed according to a program recorded in a CPU (Central Processing Unit) 11, a ROM (Read Only Memory) 12, or an HDD 19. A program run on the CPU 11 and data are stored in a RAM (Random Access Memory) 13 as the necessity arises. The CPU 11, the ROM 12, and the RAM 13 are interconnected by a bus 14.

The CPU 11 is also connected to an input and output interface 15 via the bus 14. A reception portion 16, an input portion 17, an output portion 18, the HDD 19, a communication portion 20, and a drive 21 are connected to the input and output interface 15.

The reception portion 16 receives a broadcast wave signal from an antenna 16A and obtains an MPEG-TS (Moving Picture Experts Group-Transport Stream) by decoding the received signal. The reception portion 16 obtains data of the contents to be recorded from the MPEG-TS and outputs the obtained data to the HDD 19 via the input and output interface 15.

The input portion 17 receives a signal from a remote controller and outputs information indicating the content of an operation by the user to the CPU 11 via the input and output interface 15 and the bus 14.

The output portion 18 decodes the contents which are specified to be reproduced, and makes the TV set connected to the parent recorder 1 display a video of the contents according to the obtained video signal.

The HDD 19 records the program run on the CPU 11 and various types of data, such as contents supplied from the reception portion 16 via the input and output interface 15. Contents recorded in the HDD 19 are transferred to the child recorders 2-1 through 2-3 at predetermined timing.

The communication portion 20 communicates with the child recorders 2-1 through 2-3 via the network 3 and transfers the contents to a device having the recording medium determined as the transfer destination.

When a removable medium 22, such as a magnetic disc, an optical disc, a magnetic optical disc, and a semiconductor memory, is loaded in the drive 21, the drive 21 obtains a program and data recorded in the removable media 22 loaded therein. The obtained program and data are transferred to and recorded in the HDD 19 when necessity arises.

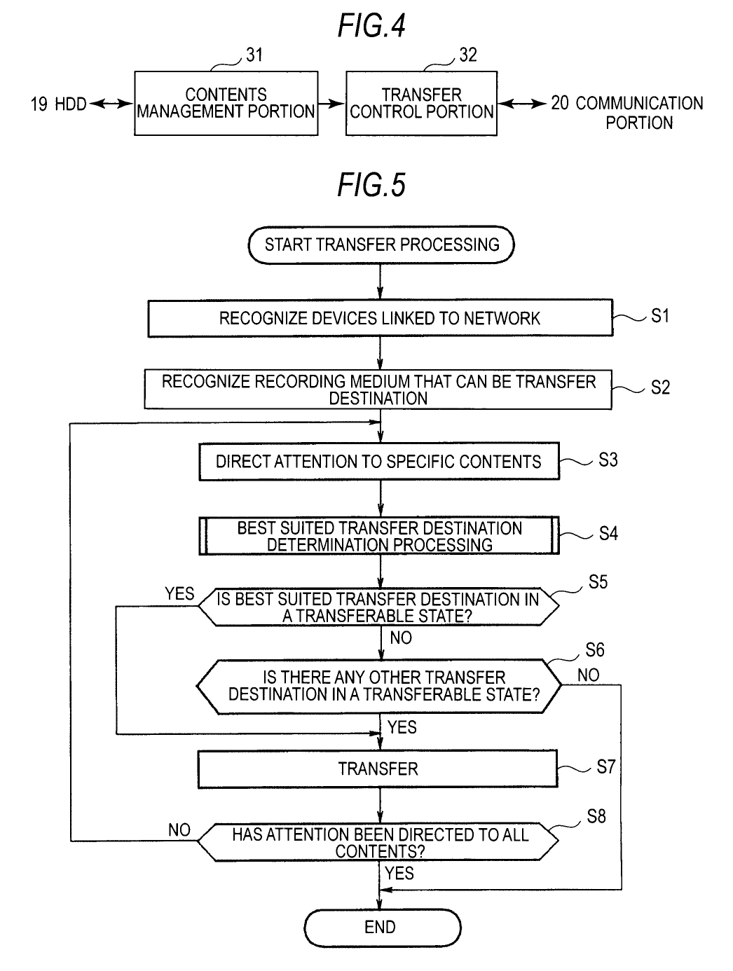

FIG. 4 is a block diagram showing an example of the functional configuration of the parent recorder 1. At least a part of the functional portions shown in FIG. 4 are achieved by running a predetermined program on the CPU 11 of FIG. 3.

As is shown in FIG. 4, a contents management portion 31 and a transfer control portion 32 are achieved in the parent recorder 1.

The contents management portion 31 manages the contents recorded in the HDD 19. For example, when the timing to transfer the contents has come, the contents management portion 31 directs attention to respective contents recorded in the HDD 19 as the contents to be transferred and outputs the contents to be transferred as well as information about the contents, such as titles, to the transfer control portion 32.

The transfer control portion 32 communicates with the child recorders 2-1 through 2-3 by controlling the communication portion 20 and obtains information about the contents recorded in the recording media in the child recorders 2-1 through 2-3. The transfer control portion 32 also determines the recording medium as the transfer destination on the basis of the information about the contents to be transferred that are supplied from the contents management portion 31 and the information obtained from the child recorders 2-1 through 2-3 and transfers the contents to the determined recording medium.

Processing by the parent recorder 1 having the configuration as above will now be described.

Transfer processing by the parent recorder 1 will be described first with reference to the flowchart of FIG. 5. This processing is started when the timing to transfer recorded contents has come.

In Step S1, the transfer control portion 32 makes communications, for example, in conformity with the DLNA by controlling the communication portion 20 and recognizes devices linked to the network 3.

In Step S2, the transfer control portion 32 recognizes a recording medium that can be a transfer destination among recording media provided in the devices recognized in Step S1.

In a case where the child recorders 2-1 through 2-3 are recognized as the devices linked to the network 3, the internal HDDs and Blu-ray discs loaded in the drives in the child recorders 2-1 through 2-3 are recognized as a recording medium that can be a transfer destination. Information about the contents recorded in the recognized recording medium, an available capacity, information indicating whether data writing is enabled or disabled, and information indicating the state of the corresponding child recorder are obtained from the corresponding child recorder among the child recorders 2-1 through 2-3 by the transfer control portion 32.

In Step S3, the contents management portion 31 directs attention to specific contents among contents recorded in the HDD 19 as the contents to be transferred. It then outputs the contents to be transferred and information about the contents to the transfer control portion 32.

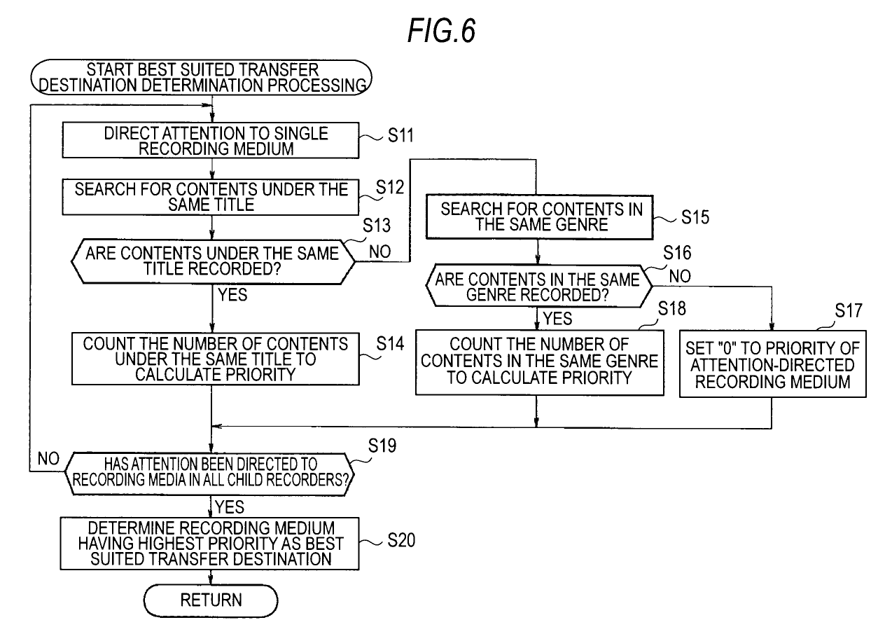

In Step S4, the transfer control portion 32 performs best suited transfer destination determination processing and determines the best suited transfer destination, which is the recording medium at the transfer destination that best suits the contents to be transferred. The best suited transfer destination determination processing will be described below with reference to FIG. 6.

In Step S5, the transfer control portion 32 determines whether the best suited transfer destination is in a transferable state.

Herein, it is determined that the best suited transfer destination is in a state where transferring is disabled, for example, in a case where an available capacity of the best suited transfer destination is smaller than a data volume of the contents to be transferred or in a case where data writing into the best suited transfer destination is disabled. Alternatively, it may be configured in such a manner that a transfer disabled state is determined in a case where the child recorder at the best suited transfer destination is in a recording state or in a case where the child recorder is preset and the recording is highly likely started while the contents are transferred.

In a case where the transfer control portion 32 determines that the best suited transfer destination is not in a transferable state in Step S5, it determines whether there is any other transfer destination in a transferable state in Step S6. In a case where the transfer control portion 32 determines that there is no other transfer destination in a transferable state in Step S6, it ends the processing and the contents will not be transferred.

Meanwhile, in a case where the transfer control portion 32 determines in Step S6 that there is any other transfer destination in a transferable state or in a case where the transfer control portion 32 determines in Step S5 that the best suited transfer destination is in a transferable state, the transfer control portion 32 transfers the contents to be transferred in Step S7.

In short, in a case where the best suited transfer destination is in a transferable state, the contents are transferred to the best suited transfer destination.

In a case where the best suited transfer destination is not in a transferable state and there is another transfer destination in a transferable state, the contents are transferred to this transfer destination in a transferable state. In a case where there is more than one transfer destination in a transferable state, a recording medium having the highest priority among priorities set to the respective recording media in the best suited transfer destination determination processing may be determined as the transfer destination.

In Step S8, the contents management portion 31 determines whether it has directed attention to all the contents. In a case where it determines that it has not directed attention to all the contents, it repeats the processing from Step S3. In a case where it determines in Step S8 that it has directed attention to all the contents, it ends the processing.

The best suited transfer destination determination processing performed in Step S4 of FIG. 5 will now be described with reference to the flowchart of FIG. 6.

In Step S11, the transfer control portion 32 directs attention to a single recording medium among the recording media recognized as recording media that can be a transfer destination.

In Step S12, the transfer control portion 32 searches for the same title as the title of the contents to be transferred among the titles of the contents recorded in the attention-directed recording medium. The titles and the genres of the contents recorded in the attention-directed recording medium are contained in the information obtained when this recording medium is recognized earlier.

In Step S13, the transfer control portion 32 determines whether contents under the same title as the title of the contents to be transferred are recorded in the attention-directed recording medium.

In a case where the transfer control portion 32 determines in Step S13 that the contents under the same title as the title of the contents to be transferred are recorded in the attention-directed recording medium, it counts the number of the contents under the same title in Step S14 to calculate the priority. Herein, for example, the number of counted contents is found as the priority.

Meanwhile, in a case where the transfer control portion 32 determines in Step S13 that the contents under the same title as the title of the contents to be transferred are not recorded in the attention-directed recording medium, it proceeds to the processing in Step S15. In Step S15, the transfer control portion 32 searches for the contents in the same genre as the genre of the contents to be transferred from the contents recorded in the attention-directed recording medium.

In Step S16, the transfer control portion 32 determines whether contents in the same genre as the genre of the contents to be transferred are recorded in the attention-directed recording medium.

In a case where the transfer control portion 32 determines in Step S16 that the contents in the same genre as the genre of the contents to be transferred are not recorded in the attention-directed recording medium, it sets “0” to the priority of the attention-directed recording medium in Step S17.

Meanwhile, in a case where the transfer control portion 32 determines in step S16 that the contents in the same genre as the genre of the contents to be transferred are recorded in the attention-directed recording medium, it counts the number of the contents in the same genre in Step S18 to calculate the priority. Herein, the priority is found, for example, as a ratio of the number of the contents in the same genre as the genre of the contents to be transferred, which is found by dividing the number of counted contents by a total number of contents recorded in the child recorder incorporating the attention-directed recording medium.

After the transfer control portion 32 calculates and sets the priority in Steps S14, S17, or S18, it determines in Step S19 whether it has directed attention to the recording media in all the child recorders. In a case where the transfer control portion 32 determines in Step S19 that it has not directed attention to the recording media in all the child recorders, it returns to Step S11 and directs attention to another recording medium to repeat the processing described above.

In a case where the transfer control portion 32 determines in Step S19 that it has directed attention to the recording media in all the child recorders, it determines the recording medium having the highest priority as the best suited transfer destination in Step S20. Thereafter, the transfer control portion 32 returns to Step S4 of FIG. 5 and performs the ensuing processing steps.

The processing described above makes it possible to transfer respective contents to a recording medium that suits better to the contents. In addition, because there is no need for the user to make an operation, such as an operation to specify the transfer destination, it is possible to lessen the burden imposed on the user in transferring contents.

In a case where there is more than one recording medium having the same value set as the priority and there is more than one candidate of the best suited transfer destination, it may be configured in such a manner that the best suited transfer destination is determined according to the priorities pre-set by the user. Likewise, in a case where there is no candidate of the best suited transfer destination, the best suited transfer destination may be determined according to the priorities pre-set by the user.

It may be configured in such a manner that the transfer destination is determined not on the basis of the titles and the genre of the contents but on the basis of a keyword. For example, in a case where a keyword can be set to each recording medium, a recording medium set with the same keyword as the keyword contained in the EPG data as information about the contents to be transferred is determined as the transfer destination.

Accordingly, by merely setting a keyword in each HDD or Blu-ray disc by the user, only the contents relevant to the pre-set keyword are transferred to the recording medium having the same keyword.

It may be configured in such a manner that the transfer destination is determined not by a single attribute, such as the title alone and the genre alone, but by a combination of two or more attributes.

A case where the device at the transfer source of the contents and the device at the transfer destination are both recorders has been described. It should be appreciated, however, that contents can be transferred as above among various types of devices capable of recording contents, such as a personal computer, a mobile phone, and a game machine.

The sequential processing described above can be achieved either by hardware or by software. In a case where the sequential processing is achieved by software, a program forming the software is installed in a computer incorporated in exclusive-use hardware or a general-purpose personal computer.

A program to be installed is provided by being recorded in the removable medium 22 shown in FIG. 3, such as an optical disc (CD-ROM (Compact Disc-Read Only Memory), DVD (Digital Versatile Disc, and so forth) and a semiconductor memory. Alternatively, it may be provided via cable or wireless transmission medium, such as local area network, the Internet, and digital broadcast. It is also possible to pre-install the program in the ROM 12 or the HDD 19.

The program run by the computer may be a program by which the processing is performed in time series in order of the description herein or a program by which processing is performed in parallel or at necessary timing, such as when it is called.

It should be appreciated the present invention is not limited to the embodiment described above and can be modified in various manners without deviating from the scope of the invention.

The present application contains subject matter related to that disclosed in Japanese Priority Patent Application JP filed in the Japan Patent Office on Jul. 23, 2008, the entire contents of which is hereby incorporated by reference.

What is claimed is:

1. An information processing apparatus comprising:
recording means for recoding contents; and
transfer means for determining recording media at transfer destinations of respective contents recorded in the recording means among recoding media in recording devices linked via a network by comparing information about contents to be transferred with information about contents recorded in the recording media in the respective recording devices and transferring the contents.

2. The information processing apparatus according to claim 1,
wherein the transfer means determines a recording medium in any of the recording devices that has recorded contents under a same title as a title of the contents to be transferred as a recording medium at a transfer destination.

3. The information processing apparatus according to claim 2,
wherein, in a case where more than one of the recording media in the recording devices has recorded the contents under the same title as the title of the contents to be transferred, the transfer means determines a recording medium having a largest number of the contents under the same title as the recording medium at the transfer destination.

4. The image processing apparatus according to claim 2,
wherein, in a case where none of the recording media in the recording devices has recorded the contents under the same title as the title of the contents to be transferred, the transfer means determines a recording medium that has recorded contents in a same genre as a genre of the contents to be transferred as the recording medium at the transfer destination.

5. The image processing apparatus according to claim 4,
wherein, in a case where more than one of the recording media in the recording devices has recorded the contents in the same genre as the genre of the contents to be transferred, the transfer means determines a recording media having a highest ratio of the number of contents in the same genre as the recording medium at the transfer destination.

6. An information processing method comprising the steps of:
determining recording media at transfer destinations of respective contents recorded in recording means for recording contents among recoding media in recording devices linked via a network by comparing information about contents to be transferred with information about contents recorded in the recording media in the respective recording devices and transferring the contents.

7. A program causing a computer to perform processing comprising the steps of:
determining recording media at transfer destinations of respective contents recorded in recording means for recording contents among recoding media in recording devices linked via a network by comparing information about contents to be transferred with information about contents recorded in the recording media in the respective recording devices and transferring the contents.

8. An information processing apparatus comprising:
a recording unit configured to record contents; and
a transfer unit configured to determine recording media at transfer destinations of respective contents recorded in the recording unit among recoding media in recording devices linked via a network by comparing information about contents to be transferred with information about contents recorded in the recording media in the respective recording devices and to transfer the contents.
